(19) United States
(12) Patent Application Publication
(10) Pub. No.: US 2025/0372040 A1
(43) Pub. Date: Dec. 4, 2025

(54) DISPLAY PANEL AND COMPENSATION METHOD THEREFOR

(71) Applicant: Shenzhen China Star Optoelectronics Semiconductor Display Technology Co., Ltd., Shenzhen (CN)

(72) Inventor: Tao BI, Shenzhen (CN)

(73) Assignee: Shenzhen China Star Optoelectronics Semiconductor Display Technology Co., Ltd., Shenzhen (CN)

(21) Appl. No.: 19/220,128

(22) Filed: May 28, 2025

(30) Foreign Application Priority Data
May 28, 2024 (CN) 202410676525.0

(51) Int. Cl. G09G 3/3233

(52) U.S. Cl. CPC G09G 3/3233; G09G 2300/0842; G09G 2320/0233

(57) ABSTRACT

A compensation method for a display panel includes: obtaining display data of the display panel for a current frame; determining a voltage offset value of the display panel corresponding to the current frame based on the display data; determining a first compensation value for a first sub-pixel based on a first weight of the first sub-pixel and the voltage offset value, and determining a second compensation value for a second sub-pixel based on a second weight of the second sub-pixel and the voltage offset value; and compensating for a first luminance of the first sub-pixel based on the first compensation value, and compensating for a second luminance of the second sub-pixel based on the second compensation value.

### CROSS-REFERENCE TO RELATED APPLICATION

This application claims the priority to Chinese Patent Application No. 202410676525.0, filed on May 28, 2024, the disclosure of which is incorporated herein by reference in its entirety.

### TECHNICAL FIELD

The present disclosure relates to display technologies, and more particularly, to a display panel and a compensation method therefor.

### BACKGROUND

In general, an Active Matrix Organic Light Emitting Diode (AMOLED) display panel can display a picture by means of pixel addressing technology.

In an AMOLED display panel based on external compensation, a detector may be provided in a pixel circuit of the display panel to detect and compensate for the mobility of a drive transistor in real time while sub-pixels are performing display. However, when displaying different pictures, different currents may flow through an Organic Light Emitting Diode (OLED), causing a potential offset of a low-voltage power supply signal for the pixel circuit (loaded on the first terminal of the OLED) and a corresponding potential offset at the second terminal of the OLED. Thus, the detected voltage at the second terminal of the OLED may have a corresponding potential offset, thereby reducing the reliability of the compensation and increasing the risk of occurrence of lateral bright/dark bands in the displayed pictures.

### SUMMARY

According to one or more embodiments of the present disclosure, a compensation method for a display panel is provided. The display panel includes multiple pixel units each including a first sub-pixel and a second sub-pixel. The compensation method includes: obtaining display data of the display panel for a current frame; determining a voltage offset value of the display panel corresponding to the current frame based on the display data; determining a first compensation value for the first sub-pixel based on a first weight of the first sub-pixel and the voltage offset value, and determining a second compensation value for the second sub-pixel based on a second weight of the second sub-pixel and the voltage offset value; and compensating for a first luminance of the first sub-pixel based on the first compensation value, and compensating for a second luminance of the second sub-pixel based on the second compensation value.

According to one or more embodiments of the present disclosure, a display panel includes: a plurality of pixel units each including a first sub-pixel and a second sub-pixel; a controller; and a memory storing an application program executable by the controller to perform the above compensation method for the display panel.

### BRIEF DESCRIPTION OF THE DRAWINGS

FIG. 1 is a schematic block diagram of a display panel according to one or more embodiments of the present disclosure.

FIG. 2 is a flowchart of a compensation method for a display panel according to one or more embodiments of the present disclosure.

FIG. 3 is a flowchart of a compensation method for a display panel according to one or more embodiments of the present disclosure.

FIG. 4 is a schematic diagram of a pixel circuit according to one or more embodiments of the present disclosure.

FIG. 5 is a flowchart of a compensation method for a display panel according to one or more embodiments of the present disclosure.

FIG. 6 is a flowchart of a compensation method for a display panel according to one or more embodiments of the present disclosure.

FIG. 7 is a flowchart of a compensation method for a display panel according to one or more embodiments of the present disclosure.

FIG. 8 is a correction graph for a first color sub-pixel according to one or more embodiments of the present disclosure.

FIG. 9 is a correction graph for a second color sub-pixel according to one or more embodiments of the present disclosure.

FIG. 10 is a correction graph for a third color sub-pixel according to one or more embodiments of the present disclosure.

FIG. 11 is a flowchart of a compensation method for a display panel according to one or more embodiments of the present disclosure.

FIG. 12 is a flowchart of a compensation method for a display panel according to one or more embodiments of the present disclosure.

FIG. 13 is a flowchart of a compensation method for a display panel according to one or more embodiments of the present disclosure.

FIG. 14 is a schematic block diagram of a display panel according to one or more embodiments of the present disclosure.

FIG. 15 is a schematic block diagram of a controller of a display panel according to one or more embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

In the description of the present disclosure, the terms “first”, “second” and the like are used for descriptive purposes only and are not to be construed as indicating or implying relative importance or implying the number of indicated technical features. Thus, the features limited by “first” and “second” may explicitly or implicitly include one or more of the features. In the description of the present disclosure, “multiple” means two or more. Unless expressly and specifically defined otherwise, “electrically connected” means conductive therebetween, and “connected” means conductive in some cases, non-conductive in some cases, and is not limited to direct or indirect connection therebetween.

In addition, it should be noted that the drawings provide only structures and steps in close relation to the present disclosure, and that details not substantially related to the present disclosure are omitted, so as to simplify the drawings and make the point of the present disclosure clear, rather than indicating that the device in practice is the same as those in the drawings and limiting the device in practice.

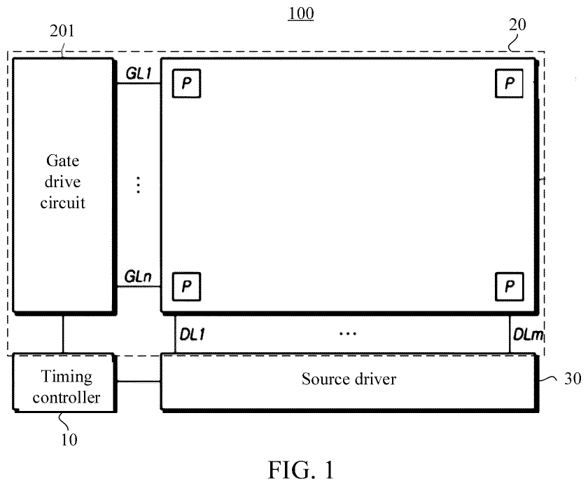

In one or more embodiments, as shown in FIG. 1, a display panel 100 includes a timing controller 10, a panel body 20 electrically connected to the timing controller 10, and source driver 30.

The panel body 20 includes a gate drive circuit 201, multiple gate lines (GLI to GLn), multiple data lines (DLI to DLm), and multiple pixel units. Each pixel unit may include a first sub-pixel P and a second sub-pixel P respectively corresponding to different colors. For example, the multiple sub-pixels P may be arranged in an array of n rows and m columns, where n and m are both positive integers. Each of the gate lines (any one of GLI to GLn) may be electrically connected to m sub-pixels P of one row, and each of the data lines (any one of DLI to DLm) may be electrically connected to n sub-pixels P of one column.

The timing controller 10 is configured to obtain display data of each sub-pixel P in the display panel 100 in each frame, and the display data may include a gray scale value of the sub-pixel P in the frame. The timing controller 10 can control the gate drive circuit 201 to output respective gate signals to the gate lines so as to control the n rows of sub-pixels P to be turned on in sequence. The source driver 30 is electrically connected to the timing controller 10 and the multiple data lines. The timing controller 10 can control the source driver 30 to output respective data signals to the data lines, so that during each row of the sub-pixels P is turned on multiple data signals are transmitted to the sub-pixels P in the row through the multiple data lines, respectively, Each data signal includes multiple data voltages respectively corresponding to multiple sub-pixels P of one column.

In one or more embodiments, each pixel unit may include the following three sub-pixels P respectively corresponding to different colors: a first sub-pixel R emitting red light, a second sub-pixel G emitting green light, and a third sub-pixel B emitting blue light, so that each pixel unit can present a color. Further, each of multiple pixel units in each frame emits light of a corresponding color and a corresponding luminance value to present a frame.

During display by the display panel 100, the scanning always starts from the upper left corner of the image and moves forward horizontally until reaching the upper right corner of the image, that is, the corresponding scanning line sequentially transmits the valid gate pulse in the corresponding gate signal from the left-most sub-pixel of the first row to the right-most sub-pixel of the first row. Then, the scanning point returns to the left quickly and starts scanning again in the second row below the first row. The process of the scanning point returning between the rows is referred to as horizontal blanking, and its duration may be referred to as H-blank stage. After all rows of the sub-pixels are scanned in this way, the scanning point returns from the lower right corner of the image to the upper left corner of the image and a new scan is started. The process of the scan point returning from the lower right corner of the image to the upper left corner of the image is referred to as vertical blanking, and its duration may be referred to as V-blank stage.

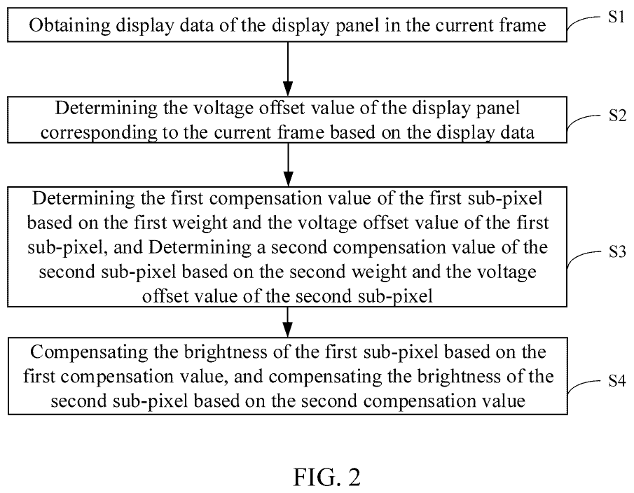

In one or more embodiments, as shown in FIG. 2, a compensation method for the display panel may include, but is not limited to, steps S1 to S4.

At step S1, display data of the display panel in the current frame is obtained.

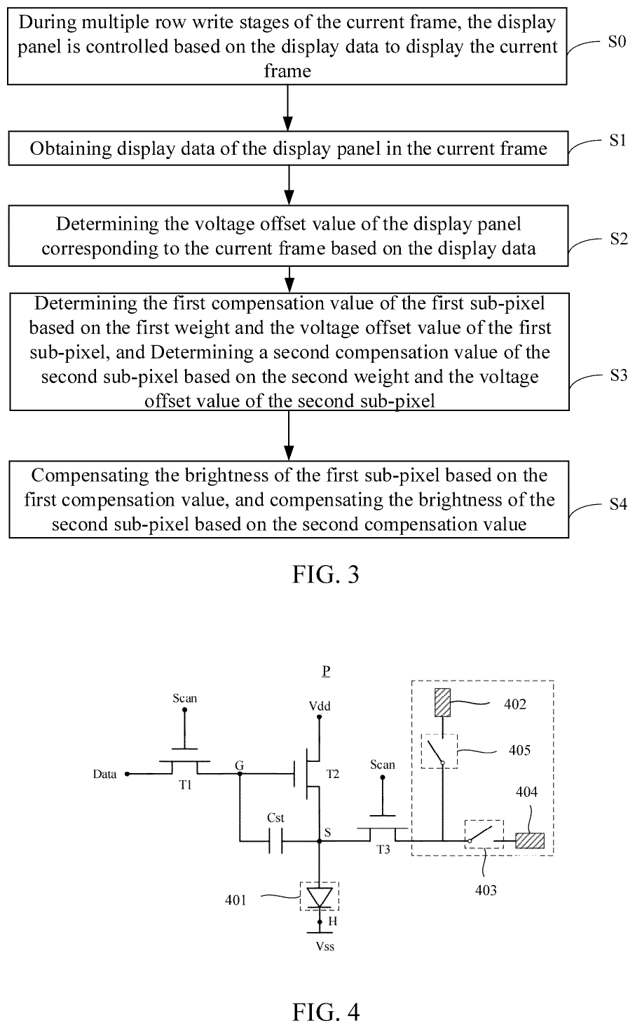

As discussed above, each frame (including the current frame) includes multiple row write stages, and the H-blank stages respectively after the multiple row write stages. As shown in FIG. 3, before step S1, the method may include but is not limited to step S0.

At step S0, during the multiple row write stages of the current frame, the display panel is controlled based on the display data to display the current frame.

Specifically, as shown in FIG. 4, each sub-pixel P (each of the first sub-pixel R, the second sub-pixel G, and the third sub-pixel B) includes a light-emitting element 401 and a pixel circuit electrically connected to the first terminal of the light-emitting element 401 through the first node H and electrically connected to the second terminal of the light-emitting element 401 through the second node S. The first node H is used to load a low voltage signal Vss, the second node S is electrically connected to a detector 402 for detecting the potential at the second node S. The light-emitting element 401 may include, but is not limited to, at least one of an Organic Light Emitting Diode (OLED), or a Light Emitting Diode (LED).

Specifically, in each frame, after obtaining the display data of each frame, the timing controller 10 may generate multiple data voltages respectively corresponding to the multiple sub-pixels P through the processing of the source driver 30. And in cooperation with the control of the multiple gate signals, before the H-blank of each row (the row write stages are respectively corresponding to the rows of the sub-pixels P (that is, the number of the gate lines)), as shown in FIG. 4, the gate signal Scan loaded by the corresponding gate line is in a valid pulse to turn on the multiple data write transistors T1 of multiple sub-pixels P in the row, so that the corresponding data voltage in the data signal “Data” transmitted by each of the data lines is output to multiple light-emitting elements 401 in multiple sub-pixels P in the corresponding row, thereby controlling the multiple light-emitting elements 401 in the multiple sub-pixels P in the corresponding row to emit light at luminance corresponding to their respective data voltages.

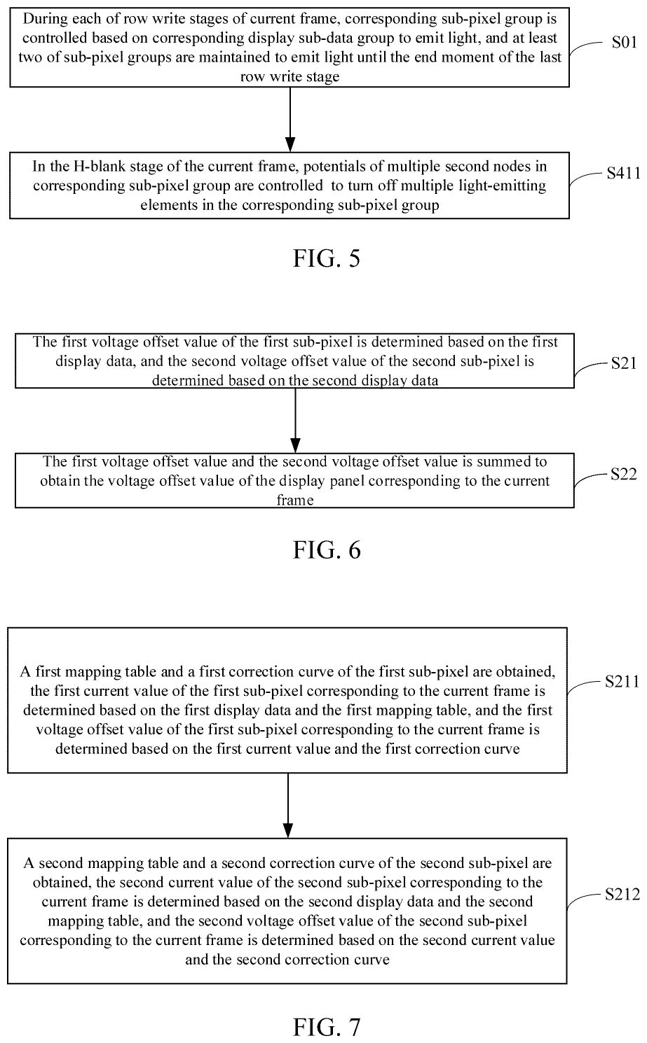

As shown in FIGS. 1 and 4, the multiple sub-pixels P include multiple sub-pixel groups (e.g., multiple sub-pixels P located in a same row) corresponding to the multiple row write stages. The display data includes multiple display sub-data groups corresponding to the multiple sub-pixel groups. The second node S is further connected to a reset circuit 404 for controlling a potential at the second node S. As shown in FIG. 5, step S0 may include but is not limited to step S01.

At step S01, during each of the row write stages of the current frame, the corresponding sub-pixel group is controlled based on the corresponding display sub-data group to emit light, and at least two of the sub-pixel groups are maintained to emit light until the end moment of the last row write stage.

It can be appreciated that, in general, each row of sub-pixels P emits light after being acted upon by the corresponding display sub-data group at the row write stage and maintains the luminance until the start time of the V-blank stage (including the last H-blank stage) of the current frame. However, in one or more embodiments of the present disclosure, only part of the sub-pixel groups are configured to keep emitting light until the end moment of the last row write stage, specifically. Specifically, in one or more embodiments of the present disclosure, during at least one V-blank stage (corresponding to at least one row of sub-pixels P), the multiple data write transistors T1 in the at least one row of sub-pixels P are turned on, and the data signal “Data” is set to be equal to an invalid low potential so as to be transmitted to the third node G (the gate of the drive transistor T2). Also, the read signal RD loaded by the gate of the read transistor T3 is set to be in a valid pulse, the first switch 403 is closed, and the reset circuit 404 is configured to input a reference voltage Vref to the second node S through the read transistor T3. At this time, the gate-source voltage of the drive transistor T2 is less than its threshold voltage to be turned off. Subsequently, the data write transistor T1 is maintained turned on, the data signal “Data” is set to be equal to an invalid high potential so as to be transmitted to the third node G, and the reference voltage Vref is still transmitted to the second node S through the read transistor T3. At this time, the gate-source voltage of the drive transistor T2 is greater than its threshold voltage so as to be gradually turned on. Subsequently, the first switch 403 is turned off, the high-voltage signal Vdd loaded by the drain of the drive transistor T2 is transmitted to the second node S, and the potential at the second node S gradually rises. At the same time, the second switch 405 is closed, and the detector 402 detects the potential at the second node S for calculating the mobility of the drive transistor T2 so as to perform corresponding mobility compensation during the subsequent display process, that is, the sub-pixel P in one or more embodiments of the present disclosure can detect and compensate the mobility in real time.

In one or more embodiments of the present disclosure, by reasonably setting the difference between the reference voltage Vref and the low-voltage signal Vss during the at least one H-blank stage, it is possible to realize that the multiple light-emitting elements 401 corresponding to the at least one row of sub-pixels P hardly emit light (i.e., the black frame insertion process), that is, the black frame insertion process is performed on the at least one row or sub-pixels P. However, it has been analyzed and found that since the V-blank stage and the light-emitting stage in the row write stage before it, multiple light-emitting elements 401 of other rows of sub-pixels P except the row continuously emit light. A large current flows to the first node H through each light-emitting element 401, causing the voltage offset of the global low-voltage signal Vss. The parasitic capacitance in each of the multiple light-emitting elements 401 in the row of sub-pixels P on which the black frame insertion process is performed causes a potential offset of the second node S connected to the multiple light-emitting element 401 in the row of sub-pixels P on which the black frame insertion process is performed, which causes an inaccurate potential at the second node S detected by the detector 402 during the H-blank stage of the row of sub-pixels P on which the black frame insertion process is performed, thereby causing an inaccurate compensation in the later stage.

Based on this, one or more embodiments of the present disclosure provide a compensation method for a display panel to eliminate the above-mentioned influence so as to compensate the detected potential at the second node S in each frame so as to improve the reliability of later compensation.

After step S1, as shown in FIGS. 2 and 3, the method may further include step S2.

At step S2, the voltage offset value of the display panel corresponding to the current frame is determined based on the display data.

Specifically, step S2 may further include obtaining a preset relationship. The voltage offset value of the display panel corresponding to the current frame may be determined based on the display data and the preset relationship. The preset relationship is used to represent a relationship between the display data and the voltage offset value.

Here, the form of the preset relationship may be, but is not limited to, a mapping table, a graph, or a functional relationship. Based on the preset relationship, if the value of one of the display data and the voltage offset value is known, the value of the other of the display data and the voltage offset value may be determined. For example, in one or more embodiments, since the display data has been obtained in step S1, the corresponding voltage offset value may be determined in step S2. The preset relationship may be stored in the memory of the display panel 100. When the compensation method is executed, the preset relationship may be called to determine the voltage offset value corresponding to the display data.

In one or more embodiments, the display data includes first display data corresponding to the first sub-pixel R and second display data corresponding to the second sub-pixel G. As shown in FIG. 6, the step S2 may include, but is not limited to, step S21.

At step S21, the first voltage offset value of the first sub-pixel is determined based on the first display data, and the second voltage offset value of the second sub-pixel is determined based on the second display data.

Of course, since the pixel unit further includes the third sub-pixel B, the display data may further include the third display data corresponding to the third sub-pixel B. Based on the preset relationship, the first voltage offset value of the first sub-pixel may also be determined based on the third display data. The preset relationship may include a first preset relationship (a relationship between the first display data and the first voltage offset value) corresponding to the first sub-pixel R, a second preset relationship (a relationship between the second display data and the second voltage offset value) corresponding to the second sub-pixel G, and a third preset relationship (a relationship between the third display data and the third voltage offset value) corresponding to the third sub-pixel B. Therefore, three voltage offset values may be determined based on the three preset relationships and three display data.

As can be seen from the above description, for each row of sub-pixels P on which the black frame insertion process is performed, the first display data may include multiple gray scale values of multiple first sub-pixels R in the frame other than the row of sub-pixels P on which the black frame insertion process is performed. Of course, if the influence of the first sub-pixels R in the row of sub-pixels P on which the black frame insertion process is performed in the row write stage on the low voltage signal Vss is taken into account, or if the sum of the gray scale values of the first sub-pixels R in the row of sub-pixels P on which the black frame insertion process is performed is considered to be negligible compared to the sum of the gray scale values of all the other first sub-pixels R, the display data herein may also include a gray scale value of each first sub-pixel R in the frame. The second display data and the third display data are set in a similar way.

In one or more embodiments, as shown in FIG. 7, the above-described S21 may include, but is not limited to, steps S211 to S212 and a combination of steps S211 to S212.

At step S211, a first mapping table and a first correction curve of the first sub-pixel are obtained, the first current value of the first sub-pixel corresponding to the current frame is determined based on the first display data and the first mapping table, and the first voltage offset value of the first sub-pixel corresponding to the current frame is determined based on the first current value and the first correction curve. The first mapping table is used to represent a relationship between the first display data and the first current value, and the first correction curve is used to represent a relationship between the first current value and the first voltage offset value.

During the row write stage of the frame, when the corresponding light-emitting element 401 emits light under the control of the corresponding data voltage (relating to the first display data), the first sub-pixel R generates a current flowing through the light-emitting element 401. The current value (that is, the first current value) relates to the gray scale value of the first sub-pixel R. Since the first display data includes multiple gray scale values of multiple first sub-pixels R, the first mapping table may be used to represent a relationship between the gray scale value of each first sub-pixel R and a corresponding first current value. Thus, the first current value of each first sub-pixel R may be determined based on the first mapping table. Of course, the first mapping table may also be used to represent a relationship between the sum of the gray scale values of the multiple first sub-pixels R and the sum of the corresponding multiple first current values. The magnitudes of both the independent variable and dependent variable in the first mapping table may respectively match the magnitudes of both the gray scale value of the first sub-pixel R and the corresponding first current value, or may respectively match the sum of the gray scale values of the multiple first sub-pixels R and the sum of the corresponding multiple first current values. In either way, the sum of the first current values of all the first sub-pixels R in the current frame (with or without the first sub-pixels R in the row of sub-pixels P on which the black frame insertion process is performed) can be obtained.

In combination with the above description, it can be seen that the sum of the gray scale values of the multiple first sub-pixels R directly affects the sum of the plurality of first current values, thereby affecting the voltage of the global low-voltage signal Vss. For the row of sub-pixels P on which the black frame insertion process is performed, the offset of the voltage of the global low-voltage signal Vss also affects the potential at the second node S by the action of the parasitic capacitance of the light-emitting element 401, resulting in an inaccurate detection.

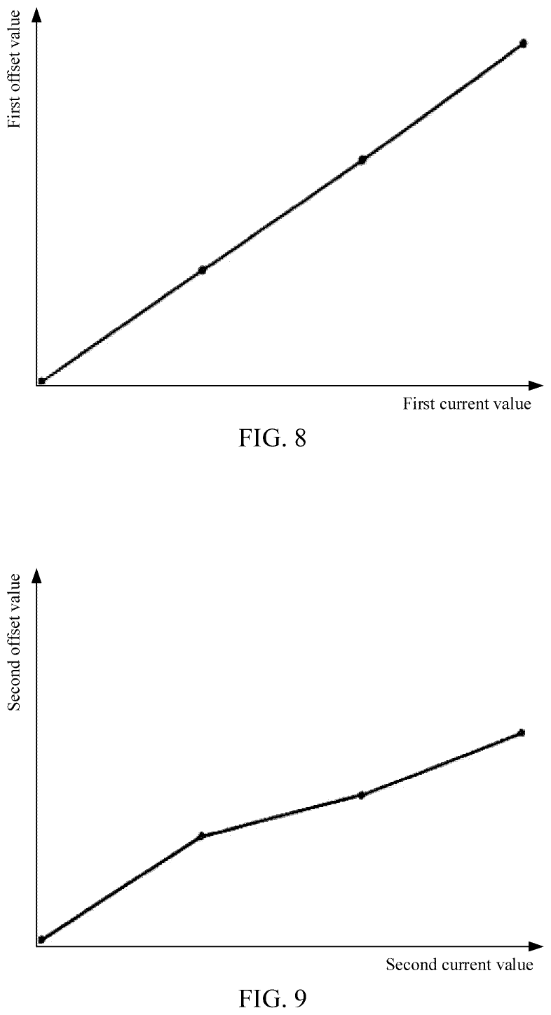

As shown in FIG. 8, the abscissa of the first correction curve indicates the sum of the “multiple first current values”, and the ordinate indicates the first voltage offset value (the theoretical value of the difference between the potential at the second node S corresponding to “the sum of the first current values” generated by the light emission of the multiple first sub-pixels R and the detected potential at the second node S in a H-blank stage under a pure black screen). The first voltage offset value may be approximately equal to the offset value of the global low-voltage signal Vss when only multiple first sub-pixels R emit light to display a pure red screen. At this time, the light-emitting element 401 emits light, and the voltage difference between the two terminals of the light-emitting element 401 may be considered to be kept constant.

Taking the first mapping table and the first correction curve as an example, in order to reduce the influence of other factors on the potential at the second node S of the first sub-pixel R, multiple display panels may be controlled to respectively display red pictures with different gray scale values, and the gray scale values of the multiple first sub-pixels R in each red picture are the same. At this time, the sum of the first current values of each display panel may be measured to obtain the first mapping table, and the first voltage offset value of each display panel may be detected to obtain the first correction curve.

At step S212, a second mapping table and a second correction curve of the second sub-pixel are obtained, the second current value of the second sub-pixel corresponding to the current frame is determined based on the second display data and the second mapping table, and the second voltage offset value of the second sub-pixel corresponding to the current frame is determined based on the second current value and the second correction curve. The second mapping table is used to represent a relationship between the second display data and the second current value, and the second correction curve is used to represent a relationship between the second current value and the second voltage offset value.

Of course, based on the presence of the third sub-pixel B, the third display data, and the third voltage offset value, there is also a third mapping table, a third current value, and a third correction curve corresponding to the third sub-pixel B. The second mapping table and the third mapping table may refer to the related description of the first mapping table, the second current value and the third current value may refer to the related description of the first current value, and the second correction curve and the third correction curve may refer to the related description of the first correction curve.

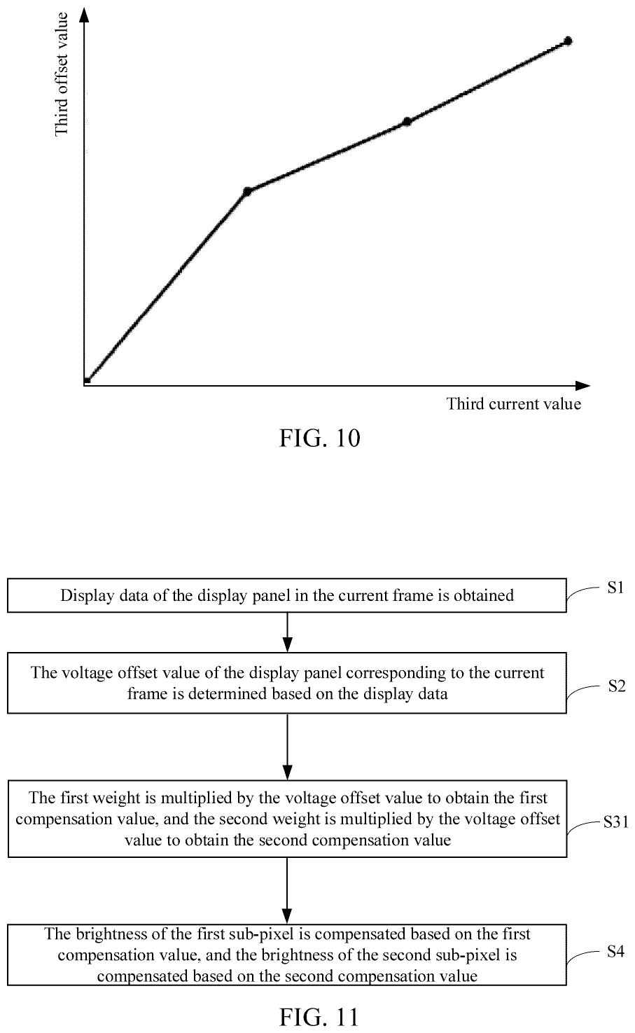

Similarly, as shown in FIG. 9, the abscissa of the second correction curve indicates the sum of the “multiple second current values”, and the ordinate indicates the second voltage offset value (the theoretical value of the difference between the potential at the second node S corresponding to “the sum of the second current values” generated by the light emission of the multiple second sub-pixels G and the detected potential at the second node S in a H-blank stage under a pure black screen). The second voltage offset value may be approximately equal to the offset value of the global low-voltage signal Vss when only multiple second sub-pixels G emit light. As shown in FIG. 10, the abscissa of the third correction curve indicates the sum of the “multiple third current values”, and the ordinate indicates the third voltage offset value (the theoretical value of the difference between the potential at the second node S corresponding to “the sum of the second current values” generated by the light emission of the multiple third sub-pixels B and the detected potential at the second node S in a H-blank stage under a pure black screen). The third voltage offset value may be approximately equal to the offset value of the global low-voltage signal Vss when only multiple third sub-pixels G emit light.

The drawing method of each of the second correction curve and the third correction curve may refer to the drawing method of the first correction curve described above.

As can be seen from FIG. 8 to FIG. 10, since the material characteristics of the light-emitting elements 401 of different color sub-pixels P are different, the shapes of the three correction curves are different. Even at the same current value, the corresponding three voltage offset values are different.

Of course, it is also possible to provide a current detector within the display panel 100 to obtain the first current value, the second current value, and third current value through detection, without the need to provide the first mapping table, the second mapping table, and third mapping tables.

After step S21, as shown in FIG. 6, the method may further include step S22.

At step S22, the first voltage offset value and the second voltage offset value is summed to obtain the voltage offset value of the display panel corresponding to the current frame.

Of course, based on the presence of the third voltage offset value, the “voltage offset value” in step S22 may be understood as the sum of the first voltage offset value, the second voltage offset value, and the third voltage offset value.

It can be appreciated that, since the display data applied to multiple sub-pixels P in each frame affects the voltage of the global low-voltage signal Vss, in one or more embodiments, the difference in material characteristics of the light-emitting elements 401 of different color sub-pixels P is further taken into account, and the sum of the first voltage offset value, the second voltage offset value, and the third voltage offset value respectively corresponding to the three color sub-pixels was calculated as the “voltage offset value. The voltage offset values generated by different color sub-pixels P under their respective current values may be considered separately. Even if the total current values of two display screens are equal, the calculation method in one or more embodiments can take into account the differences in voltage offset values generated by different color sub-pixels P under the same current value, so that the final “voltage offset value” has high accuracy

After step S2, as shown in FIGS. 2 and 3, the method may further include step S3.

At step S3, the first compensation value of the first sub-pixel is determined based on the first weight and the voltage offset value of the first sub-pixel, and a second compensation value of the second sub-pixel is determined based on the second weight and the voltage offset value of the second sub-pixel.

Step S3 may be understood as obtaining the first weight and the second weight, and determining the first compensation value and the second compensation value based on the voltage offset value and the first weight and the second weight, respectively. Of course, based on the presence of the third voltage offset value, in S3, the third weight of the third sub-pixel B may also be obtained, and the third compensation value of the third sub-pixel is determined based on the “voltage offset value” and the third weight.

It can be seen from the above analysis that both the shape difference in the correction curves of the different color sub-pixels P and the “voltage offset value” relate to the material characteristics (which affects the magnitude of the parasitic capacitance thereof) of the light-emitting elements 401 of different color sub-pixels P. In one or more embodiments, based on the concept of the global “voltage offset value”, considering the difference in voltage change of the second node S when the same “voltage offset value” acts on different color sub-pixels P, three weights are set respectively for the three kinds of color sub-pixels based on the material characteristics of three kinds of light-emitting elements 401.

The first weight, the second weight, and the third weight may be determined by debugging before the display panel 100 leaves the factory. It may be considered that the three weights may be applicable to multiple display screens, that is, the color and the luminance of the pixel unit (including multiple sub-pixels of different colors) jointly presented by the sub-pixels of each color after being acted on by the corresponding weights are close to the color and the luminance presented by the sub-pixels of each color after being jointly acted on by the gray scale values of the three kinds of color sub-pixels. Each weight is independent of the corresponding display data, and is related to the materials of the sub-pixels.

Specifically, as shown in FIG. 11, step S3 may be understood to include step S31.

At step S31, the first weight is multiplied by the voltage offset value to obtain the first compensation value, and the second weight is multiplied by the voltage offset value to obtain the second compensation value.

Of course, based on the presence of the third weight, the third compensation value may also be equal to the product of the third weight and the “voltage offset value”. That is, the calculation of the three compensation values corresponding to the three color sub-pixels P takes into account the respective weights, so that the finally obtained three compensation values are applied to the three kinds of color sub-pixels P, respectively, and the corresponding degree of compensation is performed for the sub-pixels P of each color, thereby improving the reliability and accuracy of the “compensation”.

After step S3, as shown in FIG. 1, the method may further include step S4.

At step S4, the luminance of the first sub-pixel is compensated based on the first compensation value, and the luminance of the second sub-pixel is compensated based on the second compensation value.

Of course, based on the presence of the third compensation value, in step S4, the luminance of each of the three kinds of color sub-pixels may be compensated based on the three compensation values, respectively. The compensation herein may be in the row write stage of at least one frame after the next power-on, or in the row write stage of at least one frame after the current frame.

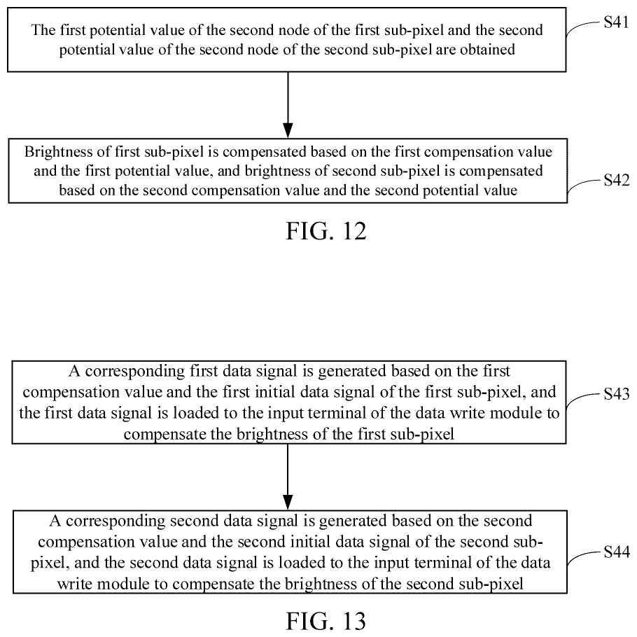

In one or more embodiments, as shown in FIG. 12, step S4 may include, but is not limited to, steps S41 to S42 and combinations of steps S41 to S42.

At step S41, the first potential value of the second node of the first sub-pixel and the second potential value of the second node of the second sub-pixel are obtained.

Of course, based on the presence of the third sub-pixel B, the third potential at the second node of the third sub-pixel B is also obtained in step S41. The measured first potential value, second potential value, and third potential value may be considered to be all affected by the offset of the voltage of the low-voltage signal Vss. If the luminance of the sub-pixels P of the three colors is compensated based on the first potential value, the second potential value, and the third potential value, respectively, the lateral bright/dark bands may be caused.

At step S42, the luminance of the first sub-pixel is compensated based on the first compensation value and the first potential value, and the luminance of the second sub-pixel is compensated based on the second compensation value and the second potential value.

Of course, based on the presence of the third sub-pixel B, the luminance of the third sub-pixel B is also compensated in step S42. It can be appreciated that, in one or more embodiments, the first compensation value, the second compensation value, and the third compensation value determined by the steps S1 to S3 and the refinement thereof have high accuracy. The first compensation value, second compensation value, and third compensation value are respectively superimposed with their respective potential values to compensate the color sub-pixels P, which has high reliability.

In summary, steps S2 and S3 are performed in at least one H-blank stage of the current frame, and step S4 is performed in multiple row write stages of the at least one frame following the current frame.

After step S01, as shown in FIG. 5, step S41 may include but is not limited to step S411.

At step S411, in the H-blank stage of the current frame the potentials of the multiple second nodes in the corresponding sub-pixel group are controlled to turn off the multiple light-emitting elements in the corresponding sub-pixel group.

As can be seen from the above description with respect to S01, in one or more embodiments of the present disclosure, only part of the sub-pixel groups (sub-pixel P of part of the rows) are set to keep emitting light until the end moment of the last row write stage, while at least one row of sub-pixels P are set to be subjected to the black frame insertion process during its H-blank stage (i.e., S411, details may be referred to the description with respect to the black frame insertion process) to execute S2 to S3.

In one or more embodiments, as shown in FIG. 4, the pixel circuit includes a data write module (including the data write transistor T1) having an input terminal (e.g., the source of the data write transistor T1) for loading a data signal (obtained based on display data); and a drive module (including the drive transistor T2) having a control terminal (for example, the gate of the drive transistor T2) electrically connected to the output terminal (for example, the drain of the data write transistor T1) of the data write module, and an output terminal (for example, the drain of the drive transistor T2) electrically connected to the second node. Further, the pixel circuit further includes a storage module (including a storage capacitor Cst) electrically connected between the control terminal of the drive module and the second node S for maintaining the potential at the third node G.

As shown in FIG. 13, step S4 may include, but is not limited to, steps S43 to S44 and a combination of steps S43 to S44.

At step S43, a corresponding first data signal is generated based on the first compensation value and the first initial data signal of the first sub-pixel, and the first data signal is loaded to the input terminal of the data write module to compensate the luminance of the first sub-pixel.

At step S44, a corresponding second data signal is generated based on the second compensation value and the second initial data signal of the second sub-pixel, and the second data signal is loaded to the input terminal of the data write module to compensate the luminance of the second sub-pixel.

Of course, based on the presence of the third sub-pixel B, step S4 may further include generating the corresponding third data signal based on the third compensation value and the third initial data signal of the third sub-pixel, and loading the third data signal to the input terminal of the data write module to compensate the luminance of the third sub-pixel.

As can be seen from the above description, in each row write stage of at least one frame after the current frame, each corresponding first sub-pixel R has a first initial data voltage (included in the first initial data signal) corresponding to the frame, each corresponding second sub-pixel G has a second initial data voltage (included in the second initial data signal) corresponding to the frame, and each corresponding third sub-pixel B has a third initial data voltage (included in the third initial data signal) corresponding to the frame. In one or more embodiments, the first compensation value, the second compensation value, and the third compensation value (each having a high precision) determined by the steps S1 to S3 and the refinement thereof are respectively processed to obtain three corresponding compensation voltages, and the data voltage (included in the first data signal, the second data signal, or the third data signal) obtained by superposing the corresponding initial data voltage on each compensation voltage is loaded to the input terminal of the corresponding data write module in the corresponding row write stage so as to control the corresponding light-emitting element 401 to emit light of correct luminance.

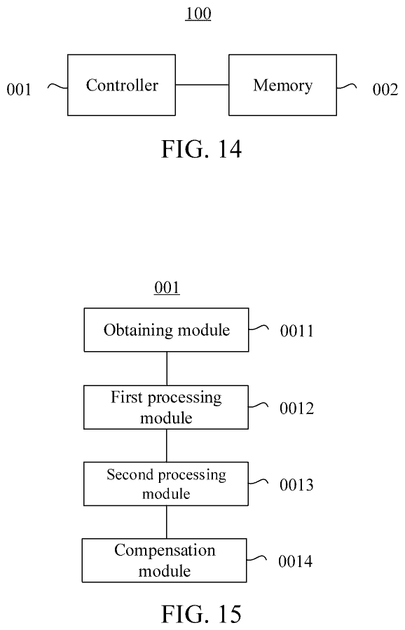

In one or more embodiments, as shown in FIG. 14, the display panel 100 includes a controller 001 for performing the compensation method for the display panel described above; and a memory 002 for storing any one of the preset relationships, the first weight, and the second weight as described above, and for storing instructions of any one of the compensation methods of the display panel described above. The technical features involved may be referred to the related description in the compensation method for the display panel described above.

In one or more embodiments, as shown in FIG. 15, the controller 001 includes a obtaining module 0011 for obtaining display data of the display panel in the current frame; a first processing module 0012 for determining based on the display data the voltage offset value of the display panel corresponding to the current frame; a second processing module 0013 for determining the first compensation value of the first sub-pixel based on the first weight of the first sub-pixel and the voltage offset value, and determining the second compensation value of the second sub-pixel based on the second weight of the second sub-pixel and the voltage offset value; a compensation module 0014 for compensating the luminance of the first sub-pixel based on the first compensation value, and compensating the luminance of the second sub-pixel based on the second compensation value. The technical features involved therein may be referred to the related description in the compensation method for the display panel described above.

One or more embodiments of the present disclosure provide a display panel and a compensation method therefor. The display data of the display panel in the current frame is obtained to determine the voltage offset value corresponding to the display data, and the weights of different color sub-pixels are applied to the voltage offset value to obtain the compensation value corresponding to the color sub-pixel, and the compensation value is adopted to compensate the luminance of the color sub-pixel. The method takes into account the different degrees of influence caused by the difference of the characteristics of the light-emitting materials of the different color sub-pixels when the voltage offset value affects the potential at the detection node, so that the weight is applied to the global voltage offset value to obtain the compensation value of each color sub-pixel, and the corresponding degree of compensation is performed on the color sub-pixel, thereby improving the reliability of the luminance compensation of the sub-pixel.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A compensation method for a display panel, wherein the display panel comprises a plurality of pixel units each comprising a first sub-pixel and a second sub-pixel, the compensation method comprising:
obtaining display data of the display panel for a current frame;
determining a voltage offset value of the display panel corresponding to the current frame based on the display data;
determining a first compensation value for the first sub-pixel based on a first weight of the first sub-pixel and the voltage offset value, and determining a second compensation value for the second sub-pixel based on a second weight of the second sub-pixel and the voltage offset value; and
compensating for a first luminance of the first sub-pixel based on the first compensation value, and compensating for a second luminance of the second sub-pixel based on the second compensation value.

2. The compensation method according to claim 1, wherein the determining of the voltage offset value comprises:
obtaining a preset relationship representing a relationship between the display data and the voltage offset value; and
determining the voltage offset value based on the display data and the preset relationship.

3. The compensation method according to claim 1, wherein each of the first sub-pixel and the second sub-pixel comprises a light-emitting element and a pixel circuit;
the pixel circuit is electrically connected to a first terminal of the light-emitting element through a first node for loading a low-voltage signal, and is electrically connected to a second terminal of the light-emitting element through a second node connected to a detector for detecting a potential at the second node;
the compensating for the first luminance of the first sub-pixel comprises:
obtaining a first potential at the second node of the first sub-pixel; and
compensating for the first luminance of the first sub-pixel based on the first compensation value and the first potential; and
the compensating for the second luminance of the second sub-pixel comprises:
obtaining a second potential at the second node of the second sub-pixel; and
compensating for the second luminance of the second sub-pixel based on the second compensation value and the second potential.

4. The compensation method according to claim 3, wherein the current frame is one of a plurality of frames, and each of the frames has a plurality of row write stages and a plurality of horizontal blanking stages respectively following the plurality of row write stages;
the compensation method further comprises: before obtaining the display data of the display panel for the current frame, controlling during the plurality of row write stages of the current frame the display panel to present a display picture of the current frame based on the display data;
the determining of the voltage offset value, the determining of the first compensation value, and the determining of the second compensation value are performed during at least one of the plurality of horizontal blanking stages of the current frame; and
the compensating for the first luminance and the compensating for the second luminance are performed during the plurality of row write stages of at least one of the frames following the current frame.

5. The compensation method according to claim 4, wherein the display panel comprises a plurality of sub-pixel groups respectively corresponding to the plurality of row write stages, and each of the sub-pixel groups comprises a plurality of sub-pixels each being one of the first sub-pixel and the second sub-pixel;
the display data comprises a plurality of display sub-data groups respectively corresponding to the plurality of sub-pixel groups;
the second node is further connected to a reset circuit for controlling the potential at the second node;
the controlling of the display panel to present the display picture of the current frame comprises:
controlling, during each of the row write stages of the current frame, one of the sub-pixel groups corresponding to the each of the row write stages to emit light based on one of the display sub-data groups corresponding to the one of the sub-pixel groups; and
controlling at least two of the sub-pixel groups to maintain emitting of light until an end moment of a last one of the row write stages of the current frame; and
during one of the horizontal blanking stages of the current frame, for each of the sub-pixels of one of the sub-pixel groups corresponding to the one of the horizontal blanking stages, the potential at the second node of the each of the sub-pixels is controlled to turn off the light-emitting element of the each of the sub-pixels to obtain the first potential at the second node of the first sub-pixel and the second potential at the second node of the second sub-pixel.

6. The compensation method according to claim 3, wherein the pixel circuit comprises: a data write circuit having an input terminal for loading a data signal; and a drive circuit having a control terminal electrically connected to an output terminal of the data write circuit and an output terminal electrically connected to the second node;
the compensating for the first luminance of the first sub-pixel comprises: generating a first data signal based on the first compensation value and a first initial data signal for the first sub-pixel, and loading the first data signal to the input terminal of the data write circuit of the first sub-pixel to compensate for the first luminance of the first sub-pixel; and
the compensating for the second luminance of the second sub-pixel comprises: generating a second data signal based on the second compensation value and a second initial data signal for the second sub-pixel, and loading the second data signal to the input terminal of the data write circuit of the second sub-pixel to compensate for the second luminance of the second sub-pixel.

7. The compensation method according to claim 1, wherein the display data comprises first display sub-data corresponding to the first sub-pixel and second display sub-data corresponding to the second sub-pixel; and
the determining of the voltage offset value comprises:
determining a first voltage offset sub-value of the first sub-pixel based on the first display sub-data, and determining a second voltage offset sub-value of the second sub-pixel based on the second display sub-data; and
summing the first voltage offset sub-value and the second voltage offset sub-value to obtain the voltage offset value.

8. The compensation method according to claim 7, wherein the determining of the first compensation value comprises: multiplying the first weight by the voltage offset value to obtain the first compensation value; and
the determining of the second compensation value comprises: multiplying the second weight by the voltage offset value to obtain the second compensation value.

9. The compensation method according to claim 7, wherein the determining of the first voltage offset sub-value comprises:
obtaining a first mapping table and a first correction curve for the first sub-pixel;
determining based on the first display sub-data and the first mapping table a first current value of the first sub-pixel corresponding to the current frame; and
determining based on the first current value and the first correction curve the first voltage offset sub-value of the first sub-pixel corresponding to the current frame, wherein the first mapping table represents a relationship between the first display sub-data and the first current value, and the first correction curve represents a relationship between the first current value and the first voltage offset sub-value; and
the determining of the second voltage offset sub-value comprises:
obtaining a second mapping table and a second correction curve for the second sub-pixel;
determining based on the second display sub-data and the second mapping table a second current value of the second sub-pixel corresponding to the current frame; and
determining based on the second current value and the second correction curve the second voltage offset sub-value of the second sub-pixel corresponding to the current frame,
wherein the second mapping table represents a relationship between the second display sub-data and the second current value, and the second correction curve represents a relationship between the second current value and the second voltage offset sub-value.

10. A display panel, comprising:
a plurality of pixel units each comprising a first sub-pixel and a second sub-pixel;
a controller; and
a memory storing an application program executable by the controller to perform operations comprising:
obtaining display data of the display panel for a current frame;
determining a voltage offset value of the display panel corresponding to the current frame based on the display data;
determining a first compensation value for the first sub-pixel based on a first weight of the first sub-pixel and the voltage offset value, and determining a second compensation value for the second sub-pixel based on a second weight of the second sub-pixel and the voltage offset value; and
compensating for a first luminance of the first sub-pixel based on the first compensation value, and compensating for a second luminance of the second sub-pixel based on the second compensation value.

11. The display panel according to claim 10, wherein the determining of the voltage offset value comprises:
obtaining a preset relationship representing a relationship between the display data and the voltage offset value; and
determining the voltage offset value based on the display data and the preset relationship.

12. The display panel according to claim 10, wherein each of the first sub-pixel and the second sub-pixel comprises a light-emitting element and a pixel circuit;
the pixel circuit is electrically connected to a first terminal of the light-emitting element through a first node for loading a low-voltage signal, and is electrically connected to a second terminal of the light-emitting element through a second node connected to a detector for detecting a potential at the second node;
the compensating for the first luminance of the first sub-pixel comprises:
obtaining a first potential at the second node of the first sub-pixel; and
compensating for the first luminance of the first sub-pixel based on the first compensation value and the first potential; and
the compensating for the second luminance of the second sub-pixel comprises:
obtaining a second potential at the second node of the second sub-pixel; and
compensating for the second luminance of the second sub-pixel based on the second compensation value and the second potential.

13. The display panel according to claim 12, wherein the current frame is one of a plurality of frames, and each of the frames has a plurality of row write stages and a plurality of horizontal blanking stages respectively following the plurality of row write stages;
the operations further comprise: before obtaining the display data of the display panel for the current frame, controlling during the plurality of row write stages of the current frame the display panel to present a display picture of the current frame based on the display data;
the determining of the voltage offset value, the determining of the first compensation value, and the determining of the second compensation value are performed during at least one of the plurality of horizontal blanking stages of the current frame; and
the compensating for the first luminance and the compensating for the second luminance are performed during the plurality of row write stages of at least one of the frames following the current frame.

14. The display panel according to claim 13, wherein the display panel comprises a plurality of sub-pixel groups respectively corresponding to the plurality of row write stages, and each of the sub-pixel groups comprises a plurality of sub-pixels each being one of the first sub-pixel and the second sub-pixel;
the display data comprises a plurality of display sub-data groups respectively corresponding to the plurality of sub-pixel groups;
the second node is further connected to a reset circuit for controlling the potential at the second node;
the controlling of the display panel to present the display picture of the current frame comprises:
controlling, during each of the row write stages of the current frame, one of the sub-pixel groups corresponding to the each of the row write stages to emit light based on one of the display sub-data groups corresponding to the one of the sub-pixel groups; and
controlling at least two of the sub-pixel groups to maintain emitting of light until an end moment of a last one of the row write stages of the current frame; and
during one of the horizontal blanking stages of the current frame, for each of the sub-pixels of one of the sub-pixel groups corresponding to the one of the horizontal blanking stages, the potential at the second node of the each of the sub-pixels is controlled to turn off the light-emitting element of the each of the sub-pixels to obtain the first potential at the second node of the first sub-pixel and the second potential at the second node of the second sub-pixel.

15. The display panel according to claim 12, wherein the pixel circuit comprises: a data write circuit having an input terminal for loading a data signal; and a drive circuit having a control terminal electrically connected to an output terminal of the data write circuit and an output terminal electrically connected to the second node;
the compensating for the first luminance of the first sub-pixel comprises: generating a first data signal based on the first compensation value and a first initial data signal for the first sub-pixel, and loading the first data signal to the input terminal of the data write circuit of the first sub-pixel to compensate for the first luminance of the first sub-pixel; and
the compensating for the second luminance of the second sub-pixel comprises: generating a second data signal based on the second compensation value and a second initial data signal for the second sub-pixel, and loading the second data signal to the input terminal of the data write circuit of the second sub-pixel to compensate for the second luminance of the second sub-pixel.

16. The display panel according to claim 10, wherein the display data comprises first display sub-data corresponding to the first sub-pixel and second display sub-data corresponding to the second sub-pixel; and
the determining of the voltage offset value comprises:
determining a first voltage offset sub-value of the first sub-pixel based on the first display sub-data, and determining a second voltage offset sub-value of the second sub-pixel based on the second display sub-data; and
summing the first voltage offset sub-value and the second voltage offset sub-value to obtain the voltage offset value.

17. The display panel according to claim 16, wherein the determining of the first compensation value comprises: multiplying the first weight by the voltage offset value to obtain the first compensation value; and
the determining of the second compensation value comprises: multiplying the second weight by the voltage offset value to obtain the second compensation value.

18. The display panel according to claim 16, wherein the determining of the first voltage offset sub-value comprises:
obtaining a first mapping table and a first correction curve for the first sub-pixel;
determining based on the first display sub-data and the first mapping table a first current value of the first sub-pixel corresponding to the current frame; and
determining based on the first current value and the first correction curve the first voltage offset sub-value of the first sub-pixel corresponding to the current frame, wherein the first mapping table represents a relationship between the first display sub-data and the first current value, and the first correction curve represents a relationship between the first current value and the first voltage offset sub-value; and
the determining of the second voltage offset sub-value comprises:
obtaining a second mapping table and a second correction curve for the second sub-pixel;
determining based on the second display sub-data and the second mapping table a second current value of the second sub-pixel corresponding to the current frame; and
determining based on the second current value and the second correction curve the second voltage offset sub-value of the second sub-pixel corresponding to the current frame,
wherein the second mapping table represents a relationship between the second display sub-data and the second current value, and the second correction curve represents a relationship between the second current value and the second voltage offset sub-value.
